(19) United States
(12) Patent Application Publication
(10) Pub. No.: US 2022/0166229 A1
(43) Pub. Date: May 26, 2022

(54) BATTERY CHARGING SYSTEM AND METHODS THEREOF

(71) Applicant: Keith Bendle, Flint, MI (US)

(72) Inventor: Keith Bendle, Flint, MI (US)

(21) Appl. No.: 17/535,198

(22) Filed: Nov. 24, 2021

Related U.S. Application Data
(63) Continuation of application No. 63/117,644, filed on Nov. 24, 2020.

(51) Int. Cl. H02J 7/00; H02J 7/34

(52) U.S. Cl. CPC H02J 7/0016; H02J 7/342; H02J 7/00034; H02J 7/0047; H02J 7/0024

(57) ABSTRACT

Embodiments herein are directed to a battery charging system provided. A charging circuit arrangement is communicatively coupled to an electronic control unit and electrically coupled to a device. The charging circuit arrangement includes a capacitor bank, a plurality of charging battery banks, a first pair of batteries, and a second pair of batteries. The plurality of charging battery banks in selective electrical communication with the capacitor bank. The first pair of batteries in selective electrical communication to the capacitor bank. The second pair of batteries in selectively electrical communication to the capacitor bank. When a charge of the first pair of batteries exceeds a minimum threshold, the electronic control unit selectively switches to the second pair of batteries to provide a power to the device and charges the first pair of batteries via a power stored within the capacitor bank with a continuous output to the device.

### CROSS REFERENCE TO RELATED APPLICATIONS

This application claims priority to the U.S. Provisional Patent Application Ser. No. 63/117,644, filed on Nov. 24, 2020, and entitled “Capacitive Battery Charger System” the entire contents of which is incorporated herein in its entirety.

### FIELD OF THE INVENTION

The present disclosure relates to battery system charging, and, more specifically, to an ultra-capacitive bank charging lithium ion battery banks without a loss of power to a charger battery bank.

### BACKGROUND

Capacitor banks are known for including a group of several capacitors of the same rating. Capacitor banks may be connected in series or parallel and banks of capacitors are used to store electrical energy and condition the flow of that energy. Further, it is known that increasing the number of capacitors in a bank will increase the capacity of energy that can be stored on a single device. Further, it is known to charge lithium ion batteries or better using other batteries such as lead batteries, and the like. However, these methods of charging the lithium ion batteries inherently generate a loss of power to charger battery.

Accordingly, there exists a need for a capacitive based lithium ion battery charging that has zero loss of power to charger battery.

### SUMMARY

In one embodiment, a battery charging system is provided. The battery charging system includes a device, an electronic control unit, and a charging circuit arrangement. The charging circuit arrangement is communicatively coupled to the electronic control unit and electrically coupled to the device. The charging circuit arrangement includes a capacitor bank, a plurality of charging battery banks, a first pair of batteries, and a second pair of batteries. The plurality of charging battery banks in selective electrical communication with the capacitor bank. The first pair of batteries in selective electrical communication with the capacitor bank. The second pair of batteries in selective electrical communication with the capacitor bank. When a charge of the first pair of batteries exceeds a minimum threshold, the electronic control unit selectively switches to the second pair of batteries to provide a power to the device and charges the first pair of batteries via a power stored within the capacitor bank to provide a continuous output to the device.

In another embodiment, a battery charging system is provided. The battery charging system includes a device, an electronic control unit, and a charging circuit arrangement. The charging circuit arrangement is communicatively coupled to the electronic control unit and electrically coupled to the device. The charging circuit arrangement includes a capacitor bank, a plurality of charging battery banks, a first pair of batteries, a second pair of batteries, and a resistor bank. The capacitor bank includes at least one ultra-capacitor. The plurality of charging battery banks in selective electrical communication with the capacitor bank. The first pair of batteries in selective electrical communication with the capacitor bank. The second pair of batteries in selective electrical communication with the capacitor bank. The resistor bank positioned in series with the capacitor bank and the first pair of batteries or the second pair of batteries. The resistor bank has at least one resistor. When a charge of the first pair of batteries exceeds a minimum threshold, the electronic control unit selectively switches to the second pair of batteries to provide a power to the device and charges the first pair of batteries via a power stored within the capacitor bank to provide a continuous output to the device.

A method for varying a resistance of a battery charging system is provided. The method includes determining a current power level of a capacitor bank of a charging circuit arrangement, determining whether the current power level of the capacitor bank is at a first reduced power level, determining whether the current power level of the capacitor bank is at a second reduced power level, and actuating a first switch of a resistor bank of the charging circuit arrangement when the current power level of the capacitor bank is at the first reduced power level. The method continues by determining whether the current power level of the capacitor bank is at a third reduced power level, and actuating a second switch of the resistor bank of the charging circuit arrangement and maintaining the actuation of the first switch of the resistor bank when the current power level of the capacitor bank is at the second reduced power level. The current power level of the capacitor bank at the first reduced power level is greater than the current power level at the second reduced power level and the current power level of the capacitor bank at the second reduced power level is greater than the current power level of the capacitor bank at the third reduced power level.

These and additional features provided by the embodiments described herein will be more fully understood in view of the following detailed description, in conjunction with the drawing s.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a battery charging system according to one or more embodiments shown and described herein;

FIG. 2 schematically depicts a charging circuit arrangement of FIG. 1 arranged to charge a capacitor bank according to one or more embodiments shown and described herein;

FIG. 3 schematically depicts the charging circuit arrangement of FIG. 2 with the capacitor bank at a full charge and the charging circuit arrangement arranged to charge a first pair of batteries according to one or more embodiments shown and described herein;

FIG. 4 schematically depicts the charging circuit arrangement of FIG. 3 with the capacitor bank at a first reduced charge and the charging circuit arrangement arranged to charge the first pair of batteries according to one or more embodiments shown and described herein;

FIG. 5 schematically depicts the charging circuit arrangement of FIG. 3 with the capacitor bank at a second reduced charge and the charging circuit arrangement arranged to charge the first pair of batteries according to one or more embodiments shown and described herein;

FIG. 6 schematically depicts the charging circuit arrangement of FIG. 3 with the capacitor bank at a third reduced charge and the charging circuit arrangement arranged to charge the first pair of batteries according to one or more embodiments shown and described herein; and

FIG. 7 depicts a flowchart of illustrative method of changing a resistance of the charging circuit arrangement of FIG. 3 based on a power level of the capacitor bank according to one or more embodiments shown or described herein.

### DETAILED DESCRIPTION

The battery charging system described herein includes an electronic control unit, a charging circuit arrangement and a device. The charging circuit arrangement implements a capacitor bank of ultra-capacitors that will charge a plurality of battery banks at a zero loss of power to charger battery because capacitors use zero power. The charging circuit arrangement permits for a first pair batteries to power a desired device external to the circuit while the capacitor bank of ultra-capacitors charges a second pair of lithium ion batteries. When a charge of the first pair of lithium ion batteries exceeds a minimum threshold, the system will switch over to the second pair of lithium ion batteries to power the desired device external to the circuit and will begin to charge the first pair of lithium ion batteries via the power stored within the capacitor bank of ultra-capacitors.

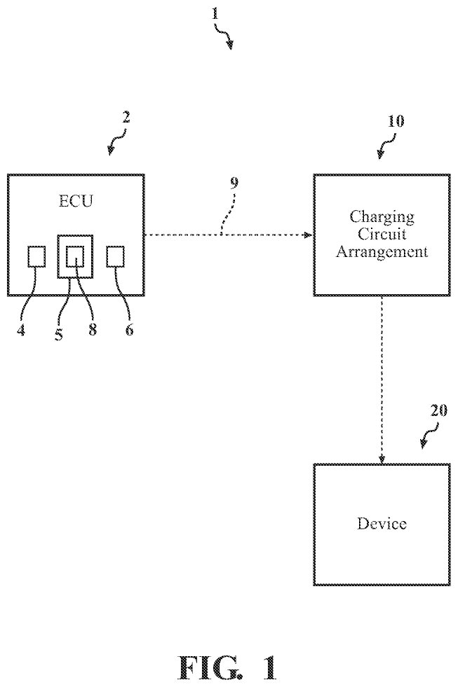

As shown in FIG. 1, the battery charging system 1 includes an electronic control unit (“ECU”) 2, a charging circuit arrangement 10 and a device 20. The ECU 2 may generally be a control device that controls the charging circuit arrangement 10 and/or one or more components thereof. As such, the ECU 2 may be communicatively coupled to the various components of the charging circuit arrangement 10 such that one or more control signals can be transmitted from the ECU to the various components, such as electrical components. In addition, the ECU 2 may be communicatively coupled to the charging circuit arrangement 10 such that signals can be transmitted/received to/from the charging circuit arrangement 10, as described in greater detail herein.

In some embodiments, the charging circuit arrangement 10 may have a plurality of sensors that capture and/or transmit power levels (e.g., current, voltage, and resistance measurements or readings gathered form the plurality of sensors). In some embodiments, the plurality of sensors may be wired to transmit data from the sensor to the ECU 2. In other embodiments, the plurality of sensors may wirelessly transmit data from the sensor to the ECU 2.

In some embodiments, the ECU 2 may be communicatively coupled to the charging circuit arrangement 10 via a network 9. The network 9 may include a wide area network (WAN), such as the Internet, a local area network (LAN), a mobile communications network, a public service telephone network (PSTN), a personal area network (PAN), a metropolitan area network (MAN), a virtual private network (VPN), and/or another network that can electronically connect the ECU 2 and the charging circuit arrangement 10 together.

In some embodiments, the network 9 may be a wired network. For example, a Controller Area Network (“CAN bus”) may be used to communicatively couple the ECU 2 to the charging circuit arrangement 10. In other example, direct wiring may be used, Ethernet connections, and/or the like may be utilized.

In various embodiments, the ECU 2 may include, but is not limited to, a processing device 4, a memory component 5, and a data storage device 6. The processing device 4, such as a computer processing unit (CPU), may be the central processing unit of the ECU 2, performing calculations and logic operations to execute a program. The processing device 4, alone or in conjunction with the other components, is an illustrative processing device, computing device, processor, or combination thereof. The processing device 4 may include any processing component configured to receive and execute instructions (such as from the memory component 5).

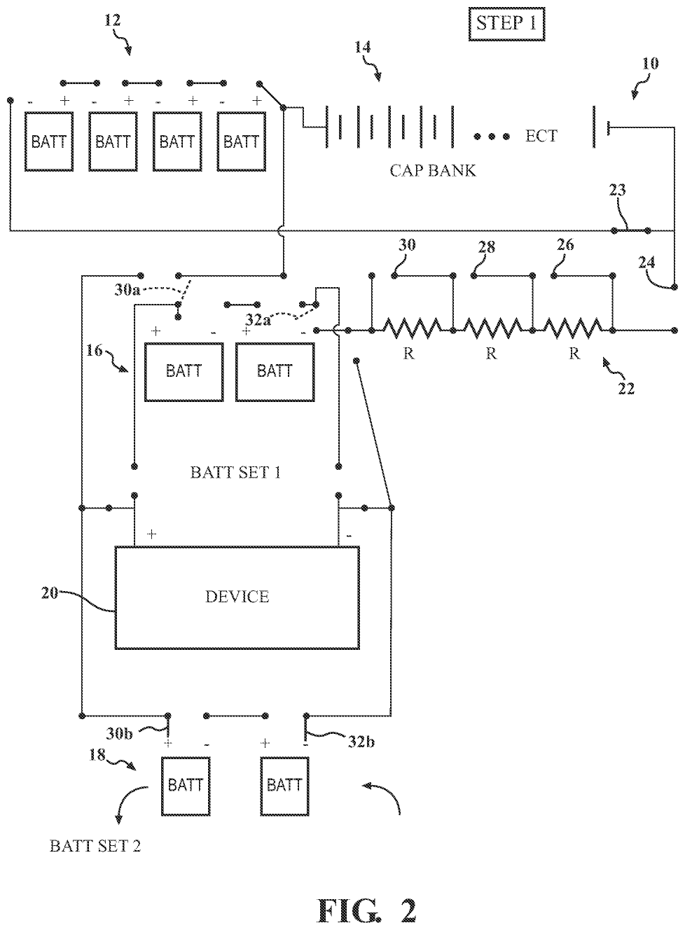

In some embodiments, the memory component 5 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. Further, the memory component 5 may be a non-transitory, processor-readable memory. The memory component 5 may include one or more programming instructions thereon that, when executed by the processing device 4, cause the processing device 4 to complete various processes, such as one or more of the processes described herein with respect to FIGS. 2-7.

Still referring to FIG. 1, the programming instructions stored on the memory component 5 may be embodied as one or more software logic modules 8, where each logic module 8 provides programming instructions for completing one or more tasks, as described in greater detail below with respect to FIGS. 2-7. Still referring to FIG. 2, the logic module 8 includes a plurality of different pieces of logic, each of which may be embodied as a computer program, firmware, and/or software/hardware, which may be executable by the processing device 4.

The data storage device 6, which may generally be a storage medium, may contain one or more data repositories for storing data that is received and/or generated. The data storage device 6 may be any physical storage medium, including, but not limited to, a hard disk drive (HDD), memory, removable storage, and/or the like. While the data storage device 6 is depicted as a local device, it should be understood that the data storage device 6 may be a remote storage device, such as, for example, a server computing device or the like. Illustrative data that may be contained within the data storage device 6 may include data related to the data gathered from the plurality of sensors, data related to charging capacity and/or current power level of a capacitor bank 14 (FIG. 2), data related to power threshold levels of the capacitor bank 14 (FIG. 2), data related to changing a resistance of the charging circuit arrangement 10 based on a power level of the capacitor bank 14 (FIG. 2), and/or the like, as described in greater detail herein.

The ECU 2 may utilize the data within the data storage device 6 to coordinate charging and/or discharging of various components of the charging circuit arrangement 10 and the device 20, as discussed in greater detail herein.

Now referring to FIGS. 2-6, the charging circuit arrangement 10 and various stages of the charging circuit arrangement 10 will be described in detail. The charging circuit arrangement 10 may include a charging battery bank 12, a capacitor bank 14, a first pair of batteries 16, a second pair of batteries 18, the device 20 to be powered, and a resistor bank 22.

The charging battery bank 12 includes a plurality of batteries, such as sealed lead-acid (SLA) batteries. Further, in the illustrated embodiments, the plurality of batteries may each be 12V connected in series for a total of 48V. This in non-limiting and there may be more or less batteries, may be more of less than a total of 48V and each battery may be more or less than 12V. The charging battery bank 12 is connected in series with the capacitor bank 14. Further, the plurality of batteries is not limited to sealed lead-acid (SLA) batteries and may be nickel-cadmium batteries, lithium-ion batteries, a combination thereof, and/or the like.

The capacitor bank 14 may contain a plurality of high value capacitors, or ultra-capacitors connected in series with one another. The number of capacitors may vary based on the amount of power to store. For example, the capacitor bank 14 may equal 25 farads when 20 capacitors are connected in series in which each capacitor is 500 farads. An ultra-capacitor cell may include a positive and negative electrode, separated by an electrolyte and store energy electrostatically, like a regular capacitor, not chemically like a battery as there may be a dielectric separator dividing the electrolyte. The small separation between electrodes may permit a higher energy storage density than a normal capacitor and the energy may be released quicker than a battery as the discharge is not dependent on a chemical reaction taking place. For example, the ultra-capacitor cell typically stores 10 to 100 times more energy per unit volume or mass than electrolytic capacitors. Further, ultra-capacitors do not degrade over time because there is not a physical or chemical changes occurring when energy or charge is stored.

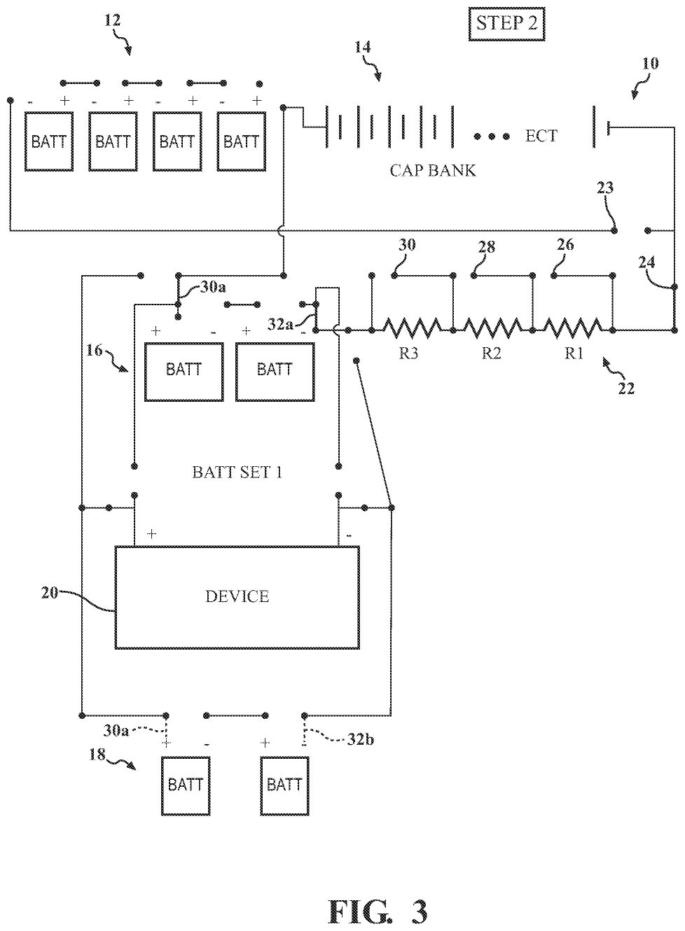

The resistor bank 22 may contain a plurality of resistors and switches. In the illustrated embodiment, the resistor bank 22 includes a set of resistors R1, R2, R3 and switches 26, 28, 30. The set of resistors R1, R2, R3 and switches 26, 28, 30 may be connected in series with the capacitor bank 14 and with each other resistor in the resistor bank 22 when the switches 26, 28, 30 are open, or disengaged from an electrical coupling. As such, based on a charge or power level of the capacitor bank 14 and predetermined thresholds, resistance values may be added or subtracted from the charging circuit arrangement 10 via actuation of the switches 26, 28, 30 to bypass some and/or all of the resistors R1, R2, R3, as discussed in greater detail herein. Further, switch 23 may be actuated to open the connection or electrically decouple the charging battery bank 12 and the capacitor bank 14 and an actuation of the switch 24 to a closed or engaged position, which electrically couples or connects the resistor bank 22 to the capacitor bank 14, as best illustrated in FIG. 3.

As such, the resistor bank 22 slows down the discharge rate of the plurality of capacitors within the capacitor bank 14 as a function of the power level of the capacitor bank 14. Because the time constant equals RC, after several charges of the plurality of capacitors within the capacitor bank 14, the subsequent charging takes minimal or close to zero time since a resistor is not being utilized in the circuit charging the plurality of capacitors within the capacitor bank 14, but instead the resistor bank 22 is only applied to the discharge side of the capacitor bank 14. As such, the resistor bank 22 has no impact on the charging battery bank 12 and/or on the first pair of batteries 16 and/or on the second pair of batteries 18.

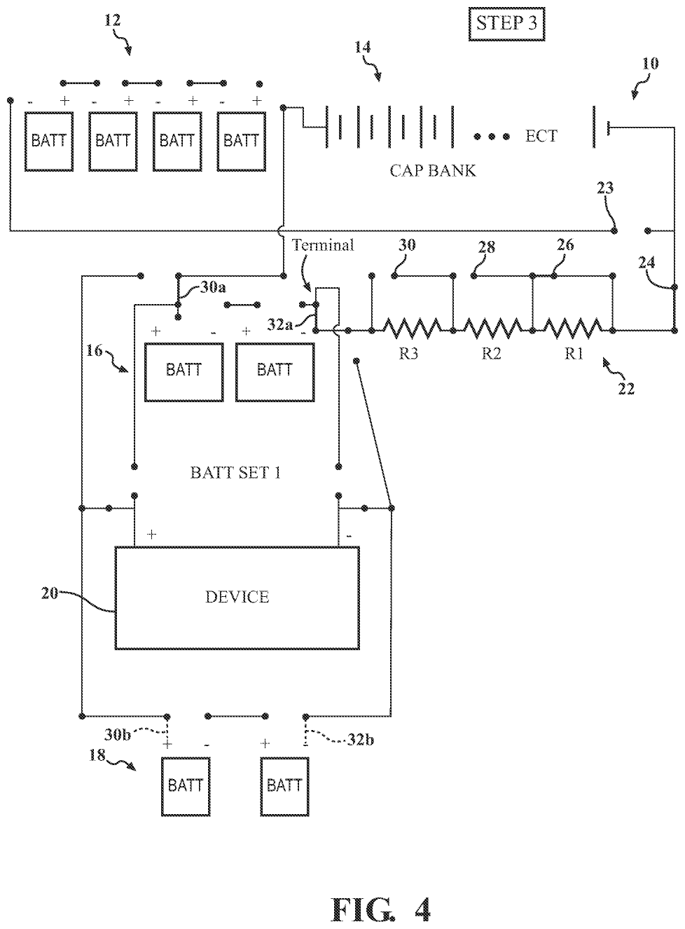

In some embodiments, the set of resistors R1, R2, R3 of the resistor bank 22 may have varying resistance characteristics. The varying resistance characteristics, for example may range from 75 ohms to 25 ohms. In other embodiments, the resistor bank 22 may include more or less than three resistors and may have equal or different resistance characteristics. Further, each of the switches 26, 28, 30 are independently actuated and may be actuated by the ECU 2 depending on a charge or power level of the capacitor bank 14. That is, as the charge or power level of the capacitor bank 14 is reduced from a full charge level to a first reduced level, at least one switch may be actuated. For example, switch 26 may be actuated to bypass resistor R1, as best illustrated in FIG. 4.

In some embodiments, a first reduced level threshold may be where the charge or power level of the capacitor bank 14 is reduced from a full charge level to a 75% level (e.g., a 75% charge remaining in the capacitor bank 14). In other embodiments, the first reduced level threshold may be where the charge or power level of the capacitor bank 14 is reduced by a 25% reduction (e.g., a value different from 75% charge remaining in the capacitor bank 14 because the charge remaining in the capacitor bank 14 did not start at 100%). It should be appreciated and understood that this is non-limiting and the first reduced level may be any change to the charge or power level of the capacitor bank 14 and not necessarily 25%, but may be greater than or less than a 25% change. Further, the first reduced level threshold may be where the charge or power level of the capacitor bank 14 is reduced from any starting charge or power level and not necessarily from a full charge level.

Further, the different reduced level thresholds may be changed, or manipulated at anytime depending on the system, capacitor bank 14 charge capacity, amount of power of voltage needed to power the device 20, and/or the like. As such, the data storage device 6 of the ECU 2 may include data relating to the different reduced level thresholds.

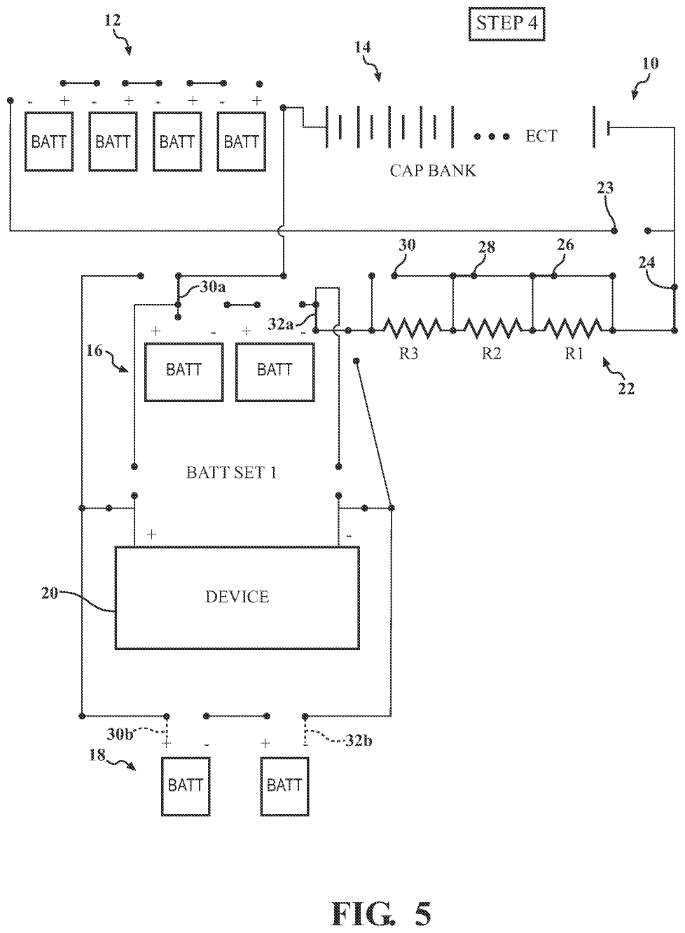

As the charge of the capacitor bank 14 is reduced from the first reduced level to a second reduced level, another switch may be actuated. For example, the ECU 2 may actuate the switch 28 to bypass the combination of resistors R1, R2, as best illustrated in FIG. 5.

In some embodiments, the second reduced level threshold may be where the charge or power level of the capacitor bank 14 is reduced from either a full charge level to a 50% level (e.g. 50% charge remaining in the capacitor bank 14) or some percentage reduced from the first reduced level (e.g., a value different from 50% charge remaining in the capacitor bank 14 because the charge remaining in the capacitor bank 14 did not start at 100%). For example, the second reduced level threshold may be where the charge or power level of the capacitor bank 14 is reduced by a 25% reduction from the first reduced level. It should be appreciated and understood that this is non-limiting and the second reduced level may be any change to the charge or power level of the capacitor bank 14 and not necessarily 50% from the full charge level or 25% reduction in charge or power level from the first reduced level, but may be greater than or less than a 25% change from the first reduced level and/or greater than or less than a 50% change from a full charge level of the capacitor bank 14. Further, the second reduced level threshold may be where the charge or power level of the capacitor bank 14 is reduced from any starting charge or power level and not necessarily from a full charge level.

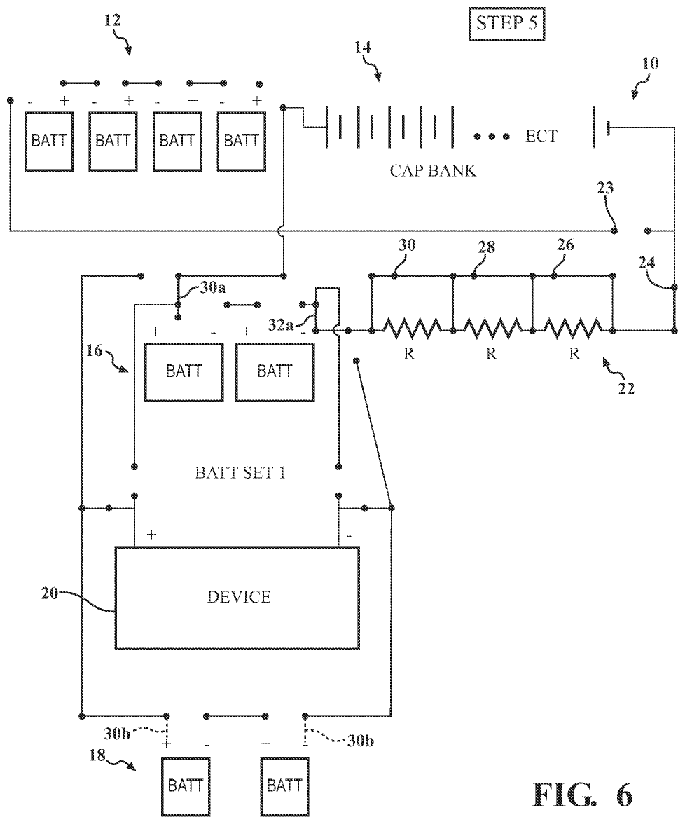

As the charge of the capacitor bank 14 is reduced from the second reduced level to a third reduced level, another switch may be actuated. For example, the ECU 2 may actuate the switch 30 to bypass resistors R1, R2, R3 of the resistor bank 22 thus making the resistor bank 22 a pass-through circuit, as best illustrated in FIG. 6.

In some embodiments, the third reduced level threshold may be where the charge or power level of the capacitor bank 14 is reduced from either a full charge level to a 75% reduction level (e.g. 25% charge remaining in the capacitor bank 14) or some percentage reduced from the second reduced level (e.g., a value different from 25% charge remaining in the capacitor bank 14 because the charge remaining in the capacitor bank 14 did not start at 100%). For example, the third reduced level threshold may be where the charge or power level of the capacitor bank 14 is reduced by a 25% reduction from the second reduced level. It should be appreciated and understood that this is non-limiting and the third reduced level may be any change to the charge or power level of the capacitor bank 14 and not necessarily 75% from the full charge level or 25% reduction from the second reduced level, but may be greater than or less than a 25% change from the second reduced level and/or greater than or less than a 75% change from a full charge level of the capacitor bank 14. Further, the third reduced level threshold may be where the charge or power level of the capacitor bank 14 is reduced from any starting charge or power level and not necessarily from a full charge level.

As such, it should be understood that each actuation of the varying switches 26, 28, 30 may be to reduce or increase the resistance of the battery charging system 1 and that the actuation may be a same switch, a different switch, and the like.

The first pair of batteries 16 and the second pair of batteries 18 may each be 12V connected in series to output 24V to the device 20. This is non-limiting and each and/or all of the first and second pair of batteries 16, 18 may be greater than or less than 12V. Further, the first pair of batteries 16 and the second pair of batteries 18 may each be lithium ion batteries, such as Bah LifePO4 batteries. This is non-limiting and each and/or all of the first and second pair of batteries 16, 18 may be batteries other than lithium ion such as hydrogen fuel cells, lithium-sulfur, graphene, redox flow, aluminum graphite, bioelectrochemical, thin film, solid state, sodium based, fluoride based, magnesium based, ammonia based, and/or the like.

The first pair of batteries 16 and the second pair of batteries 18 are independently connected to the device 20 to be powered such that, as discussed in greater detail herein, the first pair of batteries 16 and the second pair of batteries 18 may selectively provide a continuous power output to the device 20. Further, the first pair of batteries 16 and the second pair of batteries 18 may be independently connected in series and/or in parallel with the device 20 depending on the power needs of the device 20. Example power device 20 may include, without limitation, motors, generators, electronic modules, solenoids, invertors, and/or the like.

Now referring to FIG. 2, the charging circuit arrangement 10 of the battery charging system 1 is illustrated with the second pair of batteries 18 connected to the device 20 to provide a power to the device 20 via switches 30b, 32b. The capacitor bank 14 is disconnected from the first pair of batteries 16 and the second pair of batteries 18 via switch 24 being in an open configuration. Instead, the capacitor bank 14 is connected to the charging battery bank 12 via the switch 23 being in the closed, or engaged position to electrically couple the charging battery bank 12 to the capacitor bank 14. As such, the charging battery bank 12 is charging the capacitor bank 14 to a threshold charge level. For example, the threshold charge level may be dependent on a percentage charge of the capacitor bank 14, such as 100% or fully charged, or may be dependent based on a need of the first pair of batteries 16 or the second pair of batteries 18 (whichever is powering the device 20). Further, it should be understood that the size of the capacitor bank 14 may also set the threshold charge level. For example, the amount of charge or power level of the threshold charge level of the capacitor bank 14 may be based on the total charge allowed by the number of capacitors within the capacitor bank 14.

Now referring to FIG. 3, the capacitor bank 14 is charged to the threshold level and the switch 23 is opened or disconnected to disconnect or electrically decouple the capacitor bank 14 from the charging battery bank 12 and the switch 24 is engaged or electrically coupling the capacitor bank 14 to the resistor bank 22. As such, the capacitor bank 14 is now charging the first pair of batteries 16 via switches 30a, 30b. Further, R1, R2, and R3 are now connected in series between the capacitor bank 14 and the first pair of batteries 16. As such, the highest or most resistance of the charging circuit arrangement 10 is when the capacitor bank 14 is charging the first pair of batteries 16 via the switch 24. That is, when the resistance of the resistors R1, R2, R3 are in series, the amount of the resistance of the charging circuit arrangement 10 is the greatest. As such, this occurs when the capacitor bank 14 is at or near a full charge.

Now referring to FIG. 4, the capacitor bank 14 continues to charge the first pair of batteries 16, and, as the power level (i.e., voltage) in the capacitor bank 14 drops to a first reduced level, switch 26 is actuated to engage or electrically couple a bypass around resistor R1 such that now only the capacitor bank 14 continues to charge the first pair of batteries 16 utilizing resistors R2 and R3 of the resistor bank 22.

Now referring to FIG. 5, the capacitor bank 14 continues to charge the first pair of batteries 18, and, as the power level (i.e., voltage) in the capacitor bank 14 continues to drop to a second reduced level, switch 28 is actuated or engaged to electrically couple a bypass around resistor R2 such that now the capacitor bank 14 continues to charge the first pair of batteries 16 utilizing only resistor R3 of the resistor bank 22.

Now referring to FIG. 6, the capacitor bank 14 continues to charge the first pair of batteries 16, and, as the power level (i.e., voltage) in the capacitor bank 14 continues to drop to a third reduced level, switch 30 is actuated to engage or electrically couple a bypass around resistor R3 such that now only the capacitor bank 14 continues to charge the first pair of batteries 16 with the resistor bank 22 as a pass-through circuit. As such, the capacitor bank 14 continues to charge the first pair of batteries 16 until there is voltage equalization and/or until a predetermined charge threshold is met.

It should be understood that while the charging of the first pair of batteries 16 is being completed by the battery charging system 1, the second pair of batteries 18 are providing the power to the device 20.

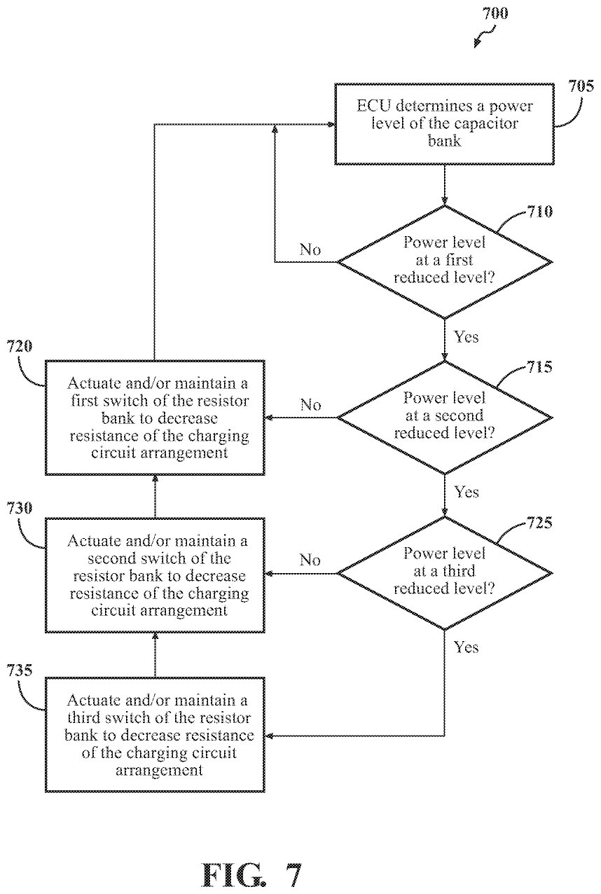

Further, it should be appreciated that while the above figures are described with respect to charging the first pair of batteries 16, the same process is followed for charging the second pair of batteries 18 via the capacitor bank 14 while the first pair of batteries 16 provide the power to the device 20. Further, it should be appreciated that this process may repeat several times before the first pair of batteries 16 achieve a voltage equalization and/or until a predetermined charge threshold is met. For example, the process as described with respect to FIGS. 2-6 and the illustrative method of FIG. 7 may be repeated multiple times, such as, for example and without limitation, 6-7 times, before the first pair of batteries 16 achieve a voltage equalization and/or until the predetermined charge threshold is met. This is non-limiting and the first pair of batteries 16 and/or the second pair of batteries 18 may achieve a voltage equalization and/or the predetermined charge threshold in fewer than 6 iterations of the process described herein or more than 7 iterations.

Further, it should be appreciated that the power and/or voltage determinations, switching of the various switches, and the like, may be performed by the ECU 2.

Further, it should be appreciated that the battery charging system 1 may be applicable in automotive applications, household applications, commercial applications, and industrial applications.

Referring now to FIG. 7 where a flow diagram that graphically depicts an illustrative method 700 of changing a resistance of the charging circuit arrangement based on a power level of the capacitor bank is provided. Although the steps associated with the blocks of FIG. 7 will be described as being separate tasks, in other embodiments, the blocks may be combined or omitted. Further, while the steps associated with the blocks of FIG. 7 will described as being performed in a particular order, in other embodiments, the steps may be performed in a different order.

At block 705, the ECU determines a power level of the capacitor bank and, at block 710, the ECU determines whether the power level of the capacitor bank is at a first reduced level. It should be understood that at least one sensor may gather, detect, and/or transmit data related to the power level of the capacitor bank to the ECU and the positioning or engagement/disengagement of the switches. The ECU and the processing device may, based on logic stored therein, lookup tables, other data and instructions stored thereon, and/or the like, determine whether the power level is at the first reduced level and the positioning of the switches for each power level of the capacitor bank. If the capacitor bank is not at the first reduced level, then the method 700 continues looping between blocks 705 and 710 until the determination is made that the power level of the capacitor bank is at the first reduced level. As such, during the looping between blocks 705-710, all of the resistors of the resistor bank may be in use.

Once determined that the power level of the capacitor bank is at the first reduced level of block 710, the ECU determines whether the power level of the capacitor bank is at the second reduced power level, at block 715. If the power level of the capacitor bank is not at the second reduced power level at block 715, the ECU actuates or maintains an actuation/engagement of a first switch of the resistor to decreases a resistance of the charging circuit arrangement, at block 720. As such, one of the resistors of the resistor bank is now bypassed, leaving, for example, two active resistors.

If it is determined that the power level of the capacitor bank is at the second reduced level at block 715, the ECU determines whether the power level of the capacitor bank is at the third reduced power level, at block 725. If the power level of the capacitor bank is not at the third reduced power level, at block 725, the ECU actuates or maintains an actuation/engagement of a second switch of the resistor bank to decrease a resistance of the charging circuit arrangement by bypassing a second resistor, at block 730, and also maintaining the an actuation/engagement of the first switch, at block 720, to bypass a first resistor. As such, two of the resistors of the resistor bank are now bypassed, leaving, for example, one active resistor.

If it is determined that the power level of the capacitor bank is at the third reduced level at block 725, the ECU actuates or maintains an actuation/engagement of a third switch of the resistor bank to decreases a resistance of the charging circuit arrangement by bypassing a third resistor, at block 735, and also maintaining an actuation/engagement of the actuation of the second switch, at block 730, and the first switch, at block 720, to bypass the first and second resistors, respectively. As such, the resistor bank is now bypassed, and acts as a pass-through circuit.

It should now be understood that the systems and methods described herein are directed to battery charging system that implements a capacitor bank that will charge a plurality of lithium ion or better battery banks at a zero loss of power to charger battery because capacitors use zero power. The charging circuit arrangement permits for a first pair of batteries to power a desired device external to the circuit while the capacitor bank charges a second pair of batteries and vice versa where the second pair of batteries power the device while the first pair of batteries are being charged by the capacitor bank. That is, when a charge of the first pair of batteries exceeds a minimum threshold, the system will switch over to the second pair of lithium ion batteries to power the desired device external to the circuit and will begin to charge the first pair of via the power stored within the capacitor bank. Moreover, a resistance of the charging circuit arrangement is varied as a function of a power level of the capacitor bank to slow down the discharge rate of the plurality of capacitors within the capacitor bank as a function of the power level of the capacitor bank.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A battery charging system comprising:
a device;
an electronic control unit; and
a charging circuit arrangement communicatively coupled to the electronic control unit and electrically coupled to the device, the charging circuit arrangement comprising:
a capacitor bank;
a plurality of charging battery banks in selective electrical communication with the capacitor bank;
a first pair of batteries in selective electrical communication with the capacitor bank;
a second pair of batteries in selective electrical communication with the capacitor bank;
wherein when a charge of the first pair of batteries exceeds a minimum threshold, the electronic control unit selectively switches to the second pair of batteries to provide a power to the device and charges the first pair of batteries via a power stored within the capacitor bank to provide a continuous output to the device.

2. The battery charging system of claim 1, wherein the capacitor bank includes at least one ultra-capacitor.

3. The battery charging system of claim 1, wherein the device is external to the charging circuit arrangement.

4. The battery charging system of claim 1, wherein the first pair of batteries are lithium ion.

5. The battery charging system of claim 1, wherein the second pair of batteries are lithium ion.

6. The battery charging system of claim 1, wherein the plurality of charging battery banks is positioned in series with the capacitor bank.

7. The battery charging system of claim 1, wherein the charging circuit arrangement further comprises:
a resistor bank positioned in series with the capacitor bank and the first pair of batteries or the second pair of batteries, the resistor bank having at least one resistor.

8. The battery charging system of claim 7, wherein the charging circuit arrangement further comprises:
a first switch assembly is positioned between the plurality of charging battery banks and the capacitor bank,
wherein the first switch assembly is configured to move between a first position, which electrically couples the plurality of charging battery banks and the capacitor bank, and a second position which electrically couples the capacitor bank and the resistor bank and decouples the plurality of charging battery banks from the capacitor bank.

9. The battery charging system of claim 7, wherein the resistor bank includes at least three resistors, each of the at least three resistors separated by independently actuatable switch assemblies.

10. The battery charging system of claim 9, wherein the independently actuatable switch assemblies move between an open position, which increases a resistance of the charging circuit arrangement and an engaged position, which causes a corresponding resistor to be bypassed decreasing the resistance of the charging circuit arrangement.

11. The battery charging system of claim 10, wherein the actuation of the independently actuatable switch assemblies is based on a power level of the capacitor bank.

12. The battery charging system of claim 11, wherein the power level of the capacitor bank includes a first reduced power level, a second reduced power level and a third reduced power level,
wherein the power level of the capacitor bank at the first reduced power level is greater than the power level at the second reduced power level and the power level of the capacitor bank at the second reduced power level is greater than the power level of the capacitor bank at the third reduced power level.

13. The battery charging system of claim 12, wherein the resistance of the charging circuit arrangement is more at the first reduced power level than at the second reduced power level and the second reduced power level and the resistance of the charging circuit arrangement at the third reduced power level is less than the resistance of the charging circuit arrangement at the second reduced power level.

14. A battery charging system comprising:
a device;
an electronic control unit; and
a charging circuit arrangement communicatively coupled to the electronic control unit and electrically coupled to the device, the charging circuit arrangement comprising:
a capacitor bank having at least one ultra-capacitor;
a plurality of charging battery banks in selective electrical communication with the capacitor bank;
a first pair of batteries in selective electrical communication with the capacitor bank;
a second pair of batteries in selective electrical communication with the capacitor bank; and
a resistor bank positioned in series with the capacitor bank and the first pair of batteries or the second pair of batteries, the resistor bank having at least one resistor,
wherein when a charge of the first pair of batteries exceeds a minimum threshold, the electronic control unit selectively switches to the second pair of batteries to provide a power to the device and charges the first pair of batteries via a power stored within the capacitor bank to provide a continuous output to the device.

15. The battery charging system of claim 14, wherein the device is external to the charging circuit arrangement.

16. The battery charging system of claim 14, wherein the charging circuit arrangement further comprises:
a first switch assembly is positioned between the plurality of charging battery banks and the capacitor bank,
wherein the first switch assembly is configured to move between a first position, which electrically couples the plurality of charging battery banks and the capacitor bank, and a second position which electrically couples the capacitor bank and the resistor bank and decouples the plurality of charging battery banks from the capacitor bank.

17. The battery charging system of claim 16, wherein the resistor bank includes at least three resistors, each of the at least three resistors separated by independently actuatable switch assemblies.

18. The battery charging system of claim 17, wherein the independently actuatable switch assemblies move between an open position, which increases a resistance of the charging circuit arrangement and an engaged position, which causes a corresponding resistor to be bypassed decreasing the resistance of the charging circuit arrangement and the actuation of the independently actuatable switch assemblies is based on a power level of the capacitor bank.

19. A method for varying a resistance of a battery charging system, the method comprising:
determining a current power level of a capacitor bank of a charging circuit arrangement;
determining whether the current power level of the capacitor bank is at a first reduced power level;
determining whether the current power level of the capacitor bank is at a second reduced power level;
actuating a first switch of a resistor bank of the charging circuit arrangement when the current power level of the capacitor bank is at the first reduced power level;
determining whether the current power level of the capacitor bank is at a third reduced power level; and
actuating a second switch of the resistor bank of the charging circuit arrangement and maintaining the actuation of the first switch of the resistor bank when the current power level of the capacitor bank is at the second reduced power level,
wherein the current power level of the capacitor bank at the first reduced power level is greater than the current power level at the second reduced power level and the current power level of the capacitor bank at the second reduced power level is greater than the current power level of the capacitor bank at the third reduced power level.

20. The method of claim 19, further comprising the steps of:
actuating a third switch of the resistor bank of the charging circuit arrangement and maintaining the actuation of the first switch and the second switch of the resistor bank when the current power level of the capacitor bank is at the third reduced power level.
